(19) United States
(12) Patent Application Publication
(10) Pub. No.: US 2020/0171466 A1
(43) Pub. Date: Jun. 4, 2020

(54) CATALYST FOR REMOVING NITROGEN OXIDES

(71) Applicants: HYUNDAI MOTOR COMPANY, Seoul (KR); KIA MOTORS CORPORATION, Seoul (KR); KOREA ADVANCED INSTITUTE OF SCIENCE AND TECHNOLOGY, Daejeon (KR)

(72) Inventors: Pyung Soon KIM, Suwon-si (KR); Chang Hwan KIM, Seongnam-si (KR); Hyunjoo LEE, Daejeon (KR); Beom-Sik KIM, Daejeon (KR); Junemin BAE, Daejeon (KR); Hojin JEONG, Daejeon (KR)

(21) Appl. No.: 16/700,147

(22) Filed: Dec. 2, 2019

Related U.S. Application Data
(60) Provisional application No. 62/775,209, filed on Dec. 4, 2018.

(51) Int. Cl. B01J 23/83; B01D 53/94; B01J 23/72; B01J 23/42; B01J 37/04

(52) U.S. Cl. CPC B01J 23/83; B01D 53/9422; B01J 37/04; B01J 23/42; B01J 23/72

(57) ABSTRACT

A catalyst for removing nitrogen includes an LNT catalyst and a Cu/CeO₂ catalyst physically mixed with the LNT catalyst.

### CROSS-REFERENCE TO RELATED APPLICATION

This application claims priority to and the benefit of U.S. Provisional Application No. 62/775,209 filed in the United States Patent and Trademark Office on Dec. 4, 2018, the entire contents of which are incorporated herein by reference.

### BACKGROUND OF THE DISCLOSURE

### (a) Technical Field

The present disclosure relates to a catalyst for removing nitrogen oxides (NOx), and in detail, relates to a catalyst for removing nitrogen oxides with improved purification performance at low temperature.

### (b) Description of the Related Art

Generally, an exhaust gas of a diesel vehicle contains carbon monoxide, hydrocarbons, and nitrogen oxide as harmful materials. Among these, problems of carbon monoxide and hydrocarbons are relatively small, but nitrogen oxides cause environmental problems such as photochemical smog and acid rain, and human disease problems. Therefore, it is required to develop a post-treatment technology of the exhaust gas with an improvement of an engine.

The storage lean NOₓ trap (LNT) catalyst is referred to as a catalyst suppressing a discharge of NOₓ by storing NOₓ in a form of nitrate in a lean burn region where NOₓ reduction due to a noble metal phase reaction is difficult. When the NOₓ storage progresses for a predetermined time, a limit NOₓ storage capacity of the catalyst is reached, and at this time, if the oxygen concentration in the exhaust gas is lowered and the reduction component such as CO/HC is increased through the engine combustion control (post injection), the stored nitrates react with a reducing agent (for example, HC, CO, H₂ etc.) and are converted into nitrogen.

(1) Reaction in a NOₓ storage period: BaCO₃+2NO₂+½O₂→Ba(NO₃)₂+CO₂

(2) Reaction in a NOₓ reduction period: Ba(NO₃)₂+2R→2NOₓ+BaO+2RO_{2.5-x}

NOₓ+R→½N₂+ROₓ

(In Reaction Equation 2, R represents the reducing agent)

The storage LNT catalyst represents NOₓ storage performance in a 100-400° C. temperature range, and represents NOₓ reduction performance at 250° C. or more. However, in the LNT catalyst for a diesel engine, since the NOₓ storage appears at a lower temperature than the temperature range, as the NOₓ storage material, cerium (Ce) is used in addition to barium (Ba). Ce has a merit that it has excellent low temperature storage performance compared to Ba, however, its storage strength is weaker than Ba, so it is the main cause of a thermal desorption phenomenon in which it does not hold more, but exhausts the stored NOₓ in case of a rapid increase of the catalyst temperature due to vehicle acceleration, which is the main cause of the deterioration of the NOₓ purification performance.

The LNT catalyst was proposed by Toyota for vehicles in the early 1990s, and was developed for lean burn gasoline catalysts. A separate three-way catalyst is disposed at the front of the LNT catalyst. Due to characteristics of the gasoline engine, the catalytic reaction temperature is higher than that of a passenger diesel engine. Therefore, a catalyst containing Ba, K, etc. as a high temperature storage material with a high content of 10 to 20 wt % was developed, and thereafter, a catalyst including a Ce component for the low temperature storage was developed.

Alumina (Al₂O₃) is mainly used as an LNT catalyst supporting member. Korean Patent Laid-Open Publication No. 2009-0086517 discloses a NOₓ storage catalyst in which a metal such as platinum (Pt), palladium (Pd), and cobalt (Co), and the barium NOₓ storage material are simultaneously carried on a porous alumina supporting member. Also, Korean Patent Laid-Open Publication No. 2010-0061152 discloses a NOₓ storage catalyst in which the catalyst is composed of a diesel fuel decomposition catalyst, a NOₓ storage layer, and a nitrogen reduction layer, barium is coated on the alumina supporting member in the nitrogen oxide storage layer, and platinum is carried on a mixture supporting member of alumina-ceria (Al₂O₃-CeO₂) in the nitrogen reduction layer. However, when barium (Ba) is carried on the alumina supporting member, barium and alumina react such that BaAl₂O₄ is formed, and this may deteriorate the NOₓ storage performance of Ba. To solve this problem, a technique of using alumina (MgAl₂O₄) having a spinel structure substituted with magnesium (Mg) as the supporting member has been developed. Also, Japanese Patent Laid-Open Publication No. 7-213902 discloses a NOₓ storage catalyst in which barium and a noble metal are carried on a mixture supporting member of alumina and ceria.

In recent years, with an announcement of EURO VI exhaust regulations, most passenger diesel vehicles will be equipped with the NOₓ abatement catalyst. Since the amount of the exhaust-permitted NOₓ in EURO VI is halved compared to EURO V, the catalyst improvement of the NOₓ reduction catalyst is more urgently required.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure provides an LNT catalyst with improved purification performance of a low temperature nitrogen oxide.

A catalyst for removing nitrogen oxides according to an exemplary embodiment of the present disclosure includes an LNT catalyst and a Cu/CeO₂ catalyst physically mixed with the LNT catalyst.

A weight ratio of the LNT catalyst and the Cu/CeO₂ catalyst may be 1:3 to 3:1.

A Cu content of the Cu/CeO₂ catalyst may be 1 to 5 wt %.

The LNT catalyst may include at least one selected from the group consisting of Pt, Ba, and Ce.

The LNT catalyst according to an exemplary embodiment of the present disclosure improves the purification performance of nitrogen oxides at low temperatures below 300° C. by mixing Cu/CeO₂ with an existing LNT catalyst.

### BRIEF DESCRIPTION OF THE DRAWINGS

FIG. 1 is a view showing a removal principle of nitrogen oxide in a typical LNT catalyst.

FIG. 2 is a view showing a method of synthesizing Cu/CeO₂ according to an exemplary embodiment of the present disclosure.

FIG. 3 is a view showing a structure of a reaction device used in an evaluation of the present disclosure.

FIG. 4 is a view showing evaluation of a purification performance while differentiating an application method of Cu/CeO₂ to an LNT catalyst.

FIG. 5 is a view showing a measurement of purification efficiency while varying a Cu content of a mixed Cu/CeO₂ catalyst.

FIG. 6 is a view showing a measurement of purification efficiency while varying a mixture ratio of an LNT catalyst and Cu/CeO_{2.}

FIG. 7 is a view showing a measurement of a NOₓ storage speed for various catalyst combinations.

FIG. 8 is a view showing a measurement of NO oxidation performance for various catalyst combinations.

FIG. 9 is a view showing a measurement of a H₂ generation amount for various catalyst combinations.

FIG. 10 is a view showing a measurement of a H₂ generation amount under a lean/rich condition.

### DETAILED DESCRIPTION OF THE EMBODIMENTS

Now, an LNT catalyst according to an exemplary embodiment of the present disclosure will be described in detail with reference to accompanying drawings.

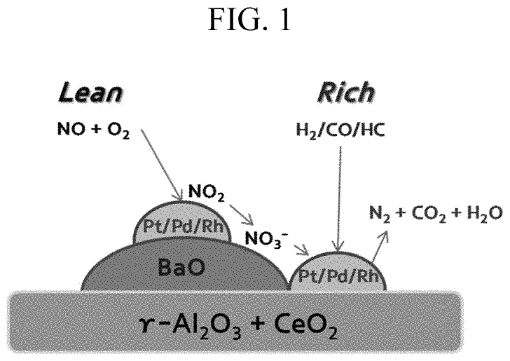

FIG. 1 is a view showing a removal principle of a nitrogen oxide in a typical LNT catalyst. The LNT catalyst is mainly used in a diesel engine vehicle as the NOₓ removal catalyst through lean/rich control. In the typical LNT catalyst, NO is oxidized into NO₂ in a lean atmosphere on a noble metal catalyst and stored to a Ba site. Next, stored NOₓ in a rich atmosphere is reduced to N₂ by the reaction with reducing agents gases of H₂, CO, and HC.

However, in a case of a current commercial LNT, NOₓ purification performance appears in the temperature range of 250-350° C. However, according to introduction of a real driving emission (RDE), the NOₓ purification performance requires introduction of an excellent LNT catalyst at the low temperature (150-200° C.).

To improve the NOₓ purification performance at low temperature, it is necessary to improve both NOₓ storage amount and reduction efficiency at low temperatures. Therefore, it is necessary to improve the purification performance by adding a functional material for improving the low temperature NOₓ storage and the reduction to the existing LNT catalyst.

Accordingly, the LNT catalyst according to an exemplary embodiment of the present disclosure improves the low temperature NOₓ purification performance by applying a non-noble metal catalyst (Cu/CeO₂) to the present LNT catalyst.

It is described in detail below.

The LNT catalyst according to an exemplary embodiment of the present disclosure improves the low temperature purification performance by mixing a non-noble metal catalyst (Cu/CeO₂) with the existing LNT catalyst.

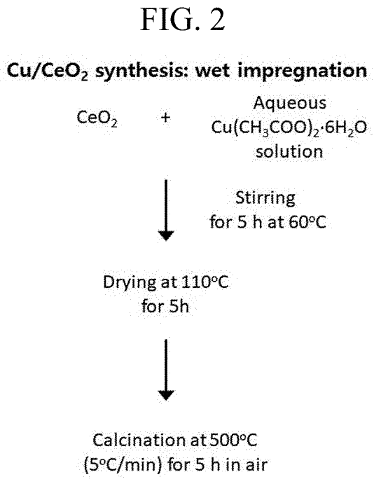

FIG. 2 is a view showing a method of synthesizing Cu/CeO₂ according to an exemplary embodiment of the present disclosure.

The Cu/CeO₂ catalyst according to the present disclosure is manufactured by impregnating Cu to the CeO₂ supporting member, and the catalyst is dried at 110° C. for 5 hours or more and then heated for 5 hours while increasing the temperature to 500° C. with a 5° C./min ramping rate in a furnace.

The manufactured Cu/CeO₂ catalyst is mixed with an LNT catalyst (1 wt % Pt/10 wt % Ba/CeO₂) and the NOₓ purification performance is evaluated.

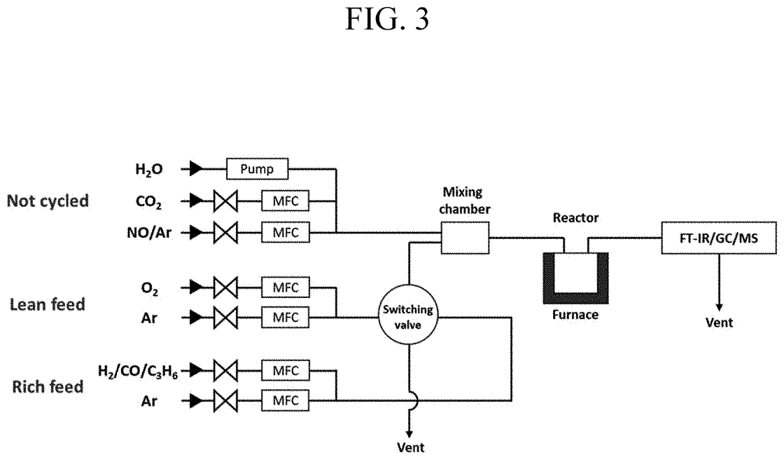

The NOₓ purification performance is evaluated in an experimental condition as shown in Table 1 below by using a reaction apparatus shown in FIG. 3.

TABLE 1

| | Lean | Rich |
|---|---|---|
| Duration (min) | 12 | 2 |
| Space velocity (mLg_{cat}⁻¹h⁻¹ | 120,000 | 120,000 |
| NO (ppm) | 200 | 200 |
| O₂ (%) | 8 | — |
| CO (%) | — | 2 |
| H₂O (%) | 5 | 5 |
| Ar | Balance | Balance |

That is, in a catalyst activation evaluation with the conditions as in Table 1, 0.1 g of a powder type of catalyst is filled in a quartz reaction tube, a 1% H₂/Ar gas is flowed therein, and a pretreatment is performed at 500° C. for 1 hour, and then the lean/rich conditions are repeated, and the NOₓ purification performance is evaluated according to the reaction temperature.

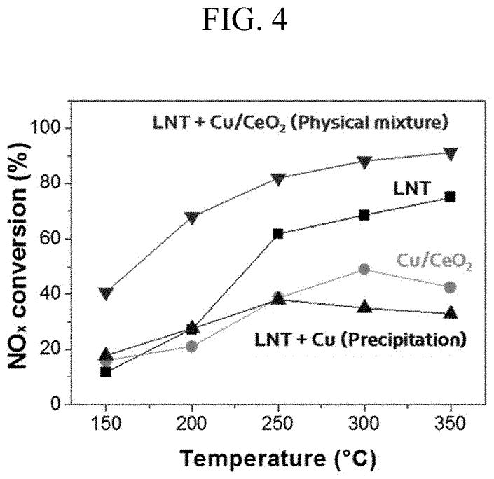

First, the purification performance is evaluated while differentiating the application method of the Cu/CeO₂ method to the LNT catalyst, and a result thereof is shown in FIG. 4.

Referring to FIG. 4, the performance of the catalyst in which Cu/CeO₂ is physically mixed with the LNT catalyst is excellent compared with a single usage of the LNT catalyst or Cu/CeO₂. Also, as confirmed through FIG. 4, when mixing Cu with the LNT catalyst by a precipitation method, the purification performance is reduced compared to the cases of the physical mixing or the usage alone.

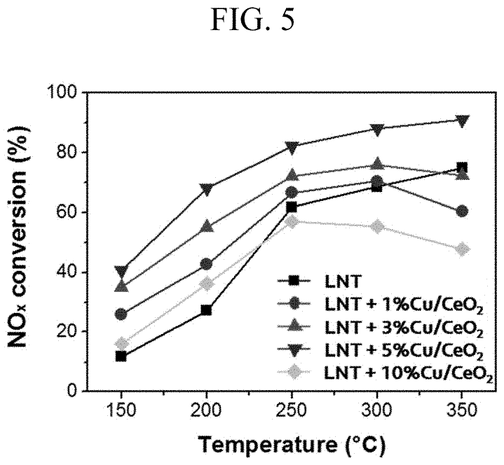

The purification efficiency is measured while differentiating the Cu content of the mixed Cu/CeO₂ catalyst, and is shown in FIG. 5. Referring to FIG. 5, when the Cu content of Cu/CeO₂ is 1-5 wt %, the improvement of the low temperature performance below 300° C. is effective.

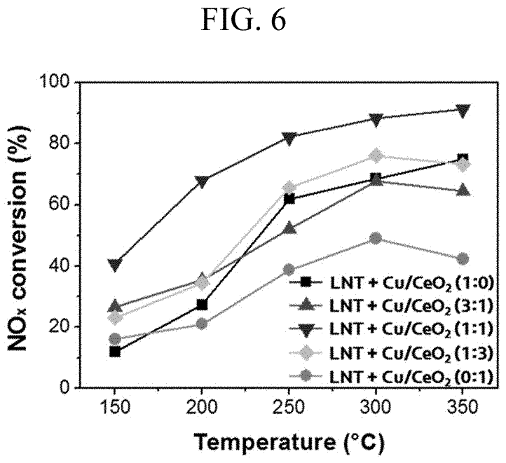

Also, the purification efficiency is measured while differentiating a mixture ratio of the LNT catalyst and Cu/CeO_{2,} and the result thereof is shown in FIG. 6. Referring to FIG. 6, the low temperature performance is improved when the mixture ratio of the LNT and Cu/CeO₂ catalyst is a 3:1-1:3 weight ratio range, and particularly the best performance appears at a 1:1 ratio.

A NOₓ purification rate according to the temperature of LNT (1 wt % Pt/10 wt % Ba/CeO₂)+5 wt % Cu/CeO₂ catalyst is measured and shown in Table 2. The total catalyst amount is equally maintained in the experiment conditions of Table 2 below. That is, in each experimental example, the contents of (1) LNT: 100 mg, (2) Cu/CeO_{2: 100} mg, (3) LNT-Cu: 100 mg, and (4) LNT+Cu/CeO_{2: 50} mg+50 mg are evaluated.

TABLE 2

| | | NOₓ | NOₓ storage | NOₓ reduction |
|---|---|---|---|---|
| Temperature | | conversion | efficiency | efficiency |
| (° C.) | Catalyst | (%) | (%)^{a} | (%)^{b} |
| 150 | LNT | 11.8 | 25.6 | 32.4 |
| | Cu/CeO₂ | 15.9 | 40.6 | 30.8 |
| | LNT-Cu | 17.8 | 47.6 | 32.4 |
| | LNT + Cu/CeO₂ | 40.0 | 61.7 | 59.4 |
| 200 | LNT | 27.2 | 33.0 | 53.9 |
| | Cu/CeO₂ | 21.0 | 43.6 | 42.8 |
| | LNT-Cu | 27.8 | 52.4 | 46.9 |
| | LNT + Cu/CeO₂ | 68.0 | 75.8 | 85.4 |
| 250 | LNT | 61.8 | 64.5 | 88.8 |
| | Cu/CeO₂ | 38.7 | 59.3 | 68.4 |
| | LNT-Cu | 37.9 | 62.7 | 55.7 |
| | LNT + Cu/CeO₂ | 82.1 | 85.7 | 93.6 |
| 300 | LNT | 68.5 | 76.0 | 91.2 |
| | Cu/CeO₂ | 49.0 | 59.0 | 75.5 |
| | LNT-Cu | 35.1 | 63.2 | 51.3 |
| | LNT + Cu/CeO₂ | 88.2 | 92.9 | 94.1 |
| 350 | LNT | 74.9 | 86.9 | 90.1 |
| | Cu/CeO₂ | 42.4 | 53.0 | 70.9 |
| | LNT-Cu | 33.1 | 61.6 | 49.2 |
| | LNT + Cu/CeO₂ | 91.3 | 93.5 | 96.4 |

${}^{a} \frac{{NOx}^{stored}}{{( {NO}^{i n} )}_{Lean}} \times 100 \%$ ${}^{b} \frac{{NOx}^{reduced}}{{NOx}^{to be reduced}} \times 100 \% = \frac{[ {NOx}^{stored} + {( {NO}^{i n} )}_{Rich} ] - {( {NOx}^{out} )}_{Rich}}{{NOx}^{stored} + {NO}_{Rich}^{i n}} \times 100 \%$

The following contents may be confirmed through Table 2. When evaluating the NOₓ purification efficiency by mixing the LNT+Cu/CeO₂ catalyst at 1:1, the NOₓ storing amount and the reduction efficiency compared to the LNT catalyst is greatly improved in the 150-350° C. temperature range.

In addition, when Cu/CeO₂ alone is used, the purification efficiency is low, and the LNT and Cu/CeO₂ catalyst have to be mixed with each other to be effective.

In addition, when the LNT is manufactured by adding Cu by the precipitation method (LNT-Cu), the NOₓ purification efficiency was not improved due to a Pt-Cu alloy, the amount of the noble metal used in LNT+Cu/CeO₂ is about 50% compared with that of the LNT catalyst, and it may be confirmed that the NOₓ purification performance is even better when the small amount of the noble metal is used.

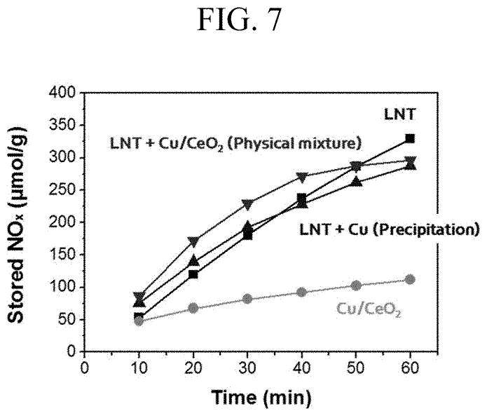

Hereinafter, various performances of the LNT Cu/CeO₂ catalyst are measured. FIG. 7 is a view showing a measurement of a NOₓ storage speed for various catalyst combinations. Referring to FIG. 7, it may be confirmed that an initial NOₓ storing speed of the catalyst in which the LNT+Cu/CeO₂ are physically mixed is high compared with other cases.

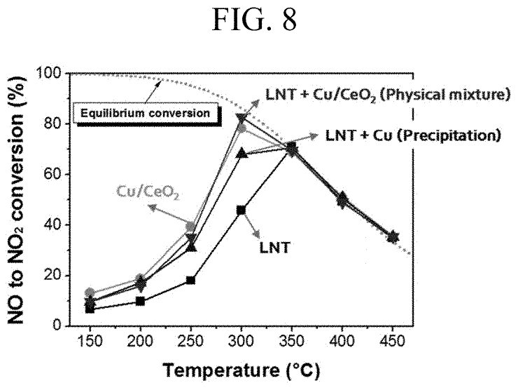

FIG. 8 is a view showing a measurement of NO oxidation performance for various catalyst combinations. Referring to FIG. 8, it may be confirmed that the NO oxidation performance is increased when the Cu/CeO₂ is mixed compared with the LNT catalyst. Therefore, the amount of low temperature NOₓ storage may be increased.

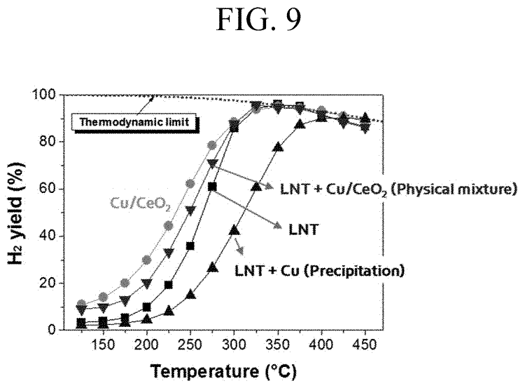

FIG. 9 is a view showing a measurement of a H2 generation amount for various catalyst combinations. H₂ is generated by a following reaction formula.

Water Gas Shift Reaction: CO+H₂O→CO₂+H₂

Through FIG. 9, it is confirmed that the H₂ generation amount is increased in the Cu/CeO₂ addition catalyst during the CO₂/H₂O injection.

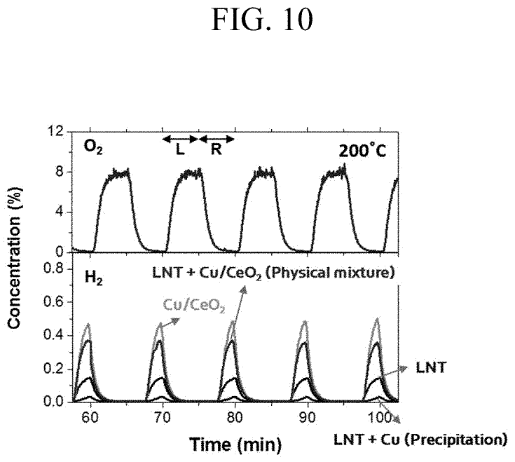

FIG. 10 is a view showing a measurement of a H₂ generation amount in a lean/rich condition. Referring to FIG. 10, when being evaluated in an exhaust gas simulation condition, the H₂ generation amount is increased in the Cu/CeO₂ addition catalyst in the rich period. The H₂ gas is an excellent reducing agent for the low temperature NOₓ reduction, and it is predicted that the low temperature NOₓ purification rate would be excellent in the Cu/CeO₂ addition catalyst because it is effective for improving the low temperature performance.

As described above, the catalyst according to the present disclosure improves the low temperature purification performance of nitrogen oxide by physically mixing the LNT catalyst and the Cu/CeO₂ catalyst.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A catalyst for removing nitrogen oxides, comprising:
a lean NOₓ trap (LNT) catalyst; and
a Cu/CeO₂ catalyst physically mixed with the LNT catalyst.

2. The catalyst for removing nitrogen oxides of claim 1, wherein
a weight ratio of the LNT catalyst and the Cu/CeO₂ catalyst is 1:3 to 3:1.

3. The catalyst for removing nitrogen oxides of claim 1, wherein
a Cu content of the Cu/CeO₂ catalyst is 1 to 5 wt %.

4. The catalyst for removing nitrogen oxides of claim 1, wherein
the LNT catalyst includes at least one selected from the group consisting of Pt, Ba, and Ce.
